(19) United States
(12) Patent Application Publication
(10) Pub. No.: US 2022/0390798 A1
(43) Pub. Date: Dec. 8, 2022

(54) PRISM LAYER AND DISPLAY DEVICE

(71) Applicant: AGC Inc., Tokyo (JP)

(72) Inventor: Masanobu ISSHIKI, Tokyo (JP)

(73) Assignee: AGC Inc., Tokyo (JP)

(21) Appl. No.: 17/885,726

(22) Filed: Aug. 11, 2022

Related U.S. Application Data
(63) Continuation of application No. PCT/JP2021/004684, filed on Feb. 8, 2021.

(30) Foreign Application Priority Data
Feb. 14, 2020 (JP) 2020-023774
Jan. 4, 2021 (JP) 2021-000196

(51) Int. Cl. G02F 1/1335; G02B 5/04

(52) U.S. Cl. CPC G02F 1/133607; G02B 5/04; G02F 1/133524

(57) ABSTRACT

The present invention relates to a prism layer (10) superimposed on the front surface of a display (20), in which: a plurality of prism parts (11) are vertically arranged; the prism parts (11) each have an upper slope surface (12) and a lower slope surface (13), and have a corner part (14) which has a forward protruding triangular shape in a cross-sectional view; the angle θ1 of the upper slope surface (12) with respect to a rear surface (15) is set to 60° to 120°, and the angle θ2 of the lower slope surface (13) with respect to the rear surface (15) is set to 5° to 45°; and the pitch Pp of a groove part (16) between the prism parts (11) is made smaller than the vertical pitch Pd of a pixel (21) of the display (20).

### CROSS-REFERENCE TO RELATED APPLICATIONS

This is a continuation of International Application No. PCT/JP2021/004684 filed on Feb. 8, 2021, and claims priority from Japanese Patent Application No. 2020-023774 filed on Feb. 14, 2020 and Japanese Patent Application No. 2021-000196 filed on Jan. 4, 2021, the entire content of which is incorporated herein by reference.

### TECHNICAL FIELD

The present invention relates to a prism layer and a display device.

### BACKGROUND ART

Display devices for displaying texts and images are required to have a property of increasing the visibility by suppressing glittering glare that is caused by reflection light of external light (antiglare property).

A technique for preventing reception of such reflection light is known in which a transparent cover is disposed at such a position as to adjoin, on the viewing side, a substrate of a case that houses a liquid crystal display device and inclining the viewing-side surface of the transparent cover with respect to the inner surface, located on the side opposite to the viewing side, of the substrate, whereby the reflection light goes out of a viewable range (refer to Patent document 1, for example).

Another technique is known in which a sheet that is formed by a transparent substrate having a bumps-and-dips shape obtained by arranging triangular-prism-shaped prisms in parallel each of which is not right-left symmetrical is stuck to the front surface of a display, whereby part, to otherwise become glittering light, of reflection light of external light goes out of a viewable range (refer to Patent documents 2 and 3, for example).

### CITATION LIST

### Patent Literature

Patent document 1: JP-A-2004-325732
Patent document 2: JP-A-H08-54503
Patent document 3: JP-A-S62-201401

### SUMMARY OF INVENTION

### Technical Problems

By the way, in the technique disclosed in the above Patent document 1, since the reflection light is caused to go out of a viewable range by inclining the entire viewing-side surface of the transparent cover, the angle of the reflection light can be deviated by only a small angle. As a result, the antiglare effect is small and the thickness of the display device is made large.

In contrast, in the technique disclosed in Patent documents 2 and 3, since the external light is reflected so as to go out of a viewable range by respective inclined surfaces of the triangular-prism-shaped prisms, the antiglare effect can be obtained while suppressing increase of the thickness of the display device. Incidentally, in Patent documents 2 and 3, no consideration is given to moire or unevenness that occurs depending on the relationship between the pitch of pixels of the display and that of the prisms.

However, it is known that moire or unevenness as mentioned above occurs in a case that a sheet having prisms that are arranged at a constant pitch is attached to a display, which poses a problem that such moire or unevenness is more conspicuous in a high-resolution display having a high pixel density. There is another problem that a displayed image looks like a double image because of the presence of light diffracted by the prism array and light transmitted by the prisms.

On the other hand, surfaces that provide an antiglare effect by a random surface shape that does not have a constant pitch are in broad use. However, it is known that unevenness called sparkling occurs when a random surface shape is combined with a display having a constant pitch. Another problem is a phenomenon called “washout” that a displayed image is blurred and looks whitish as a whole and is thereby rendered unrecognizable when strong light shines on an antiglare layer having a random shape.

In view of the above, an object of the present invention is to provide a prism layer capable of suppressing sparkling and moire effectively while suppressing occurrence of glare to such an extent that washout can be restrained in a high-resolution display, as well as a display device equipped with it.

### Solution to Problem

The invention provides the following configurations:

(1) A prism layer, a back surface of which is disposed so as to be laid on a front surface of a display that is 200 ppi or higher in pixel density and which transmits, to a front side, a display light coming from the display, the prism layer containing plural prism portions that are formed so as to extend in a horizontal direction and arranged in a top-bottom direction, in which:

each of the prism portions has a top slope, a bottom slope and a corner portion formed by the top slope and the bottom slope, has a triangular sectional shape in which the corner portion projects toward the front side, an angle of the top slope with respect to the back surface is 60° or larger and 120° or smaller, and an angle of the bottom slope with respect to the back surface is 5° or larger and 45° or smaller; and

a pitch of grooves formed between the prism portions is smaller than a pitch of pixels of the display in the top-bottom direction.

(2) A display device containing the prism layer according to item (1) and a display that is 200 ppi or higher in pixel density, in which the prism layer is laid on a front surface of the display.

(3) A display device containing:

a display; and

a prism layer which is disposed in such a manner that its back surface is laid on a front surface of the display and transmits, to a front side, a display light coming from the display, in which:

the prism layer contains plural prism portions formed so as to extend in a width direction and arranged in a top-bottom direction;

each of the prism portions has a top slope, a bottom slope and a corner portion formed by the top slope and the bottom slope, has a triangular sectional shape in which the corner portion projects toward the front side, an angle of the top slope with respect to the back surface is 60° or larger and 120° or smaller, and an angle of the bottom slope with respect to the back surface is 5° or larger and 45° or smaller;

the prism layer is disposed so as to be inclined or not to be inclined with respect to an arrangement direction in a width direction of pixels of the display; and

Pmmax(θ,Pd,Pp)≤500 μm;

θ≤30°; and

Pp≥20 μm

are satisfied, where θ is an inclination angle of the prism layer with respect to the display, Pd is a pitch of the pixels of the display, Pp is a pitch of the prism portions, Pm is a pitch of moire fringes that occur, and Pmmax(θ, Pd, Pp) is a maximum value of the pitch Pm of the moire fringes.

### Advantageous Effects of Invention

The prism layer according to the invention and the display device equipped with it can suppress sparkling and moire effectively while suppressing occurrence of glare to such an extent that washout can be restrained in a high-resolution display.

### BRIEF DESCRIPTION OF DRAWINGS

FIG. 1 is a schematic perspective view of a display device in which a prism layer according to the first embodiment is provided in a display.

FIG. 2 is a schematic vertical sectional view of the display device in which the prism layer according to the first embodiment is provided in the display.

FIGS. 3A-3C Each of FIGS. 3A-3C is a schematic vertical sectional view for description of an example structure of the prism layer.

FIGS. 4A and 4B Each of FIGS. 4A and 4B is a schematic diagram illustrating how an image formed on a display appears through the prism layer.

FIG. 5 is a schematic exploded perspective view illustrating a display device according to a modification in which a display is provided with a prism layer.

FIG. 6 is a schematic front view of a display device according to a second embodiment.

FIG. 7 is a schematic diagram indicating a manner of occurrence of moire in a display device consisting of a display and a prism layer.

FIG. 8 is a schematic diagram indicating a manner of occurrence of moire in another display device consisting of a display and a prism layer.

FIG. 9 is a schematic diagram for description of the principle of occurrence of moire fringes.

FIGS. 10A-10G Each of FIGS. 10A-10G is diagram illustrating pixel arrangements of various displays and is schematic configuration diagram of the display.

FIG. 11 is a schematic diagram for description of fringes that are formed by the pixels of a display.

FIG. 12 is a schematic sectional view of a display device that is equipped with a diffusion layer between a display and a prism layer.

FIG. 13 is a schematic sectional view of a prism layer having a chamfered portion at a corner portion of each prism portion.

FIG. 14 is a schematic sectional view of a prism layer having a curved recess at each groove formed between prism portions.

FIG. 15 is a schematic sectional view of a display device that is equipped with a visor and a shield.

### DESCRIPTION OF EMBODIMENTS

Embodiments of the present invention will be hereinafter described in detail with reference to the drawings.

### First Embodiment

First, a first embodiment will be described.

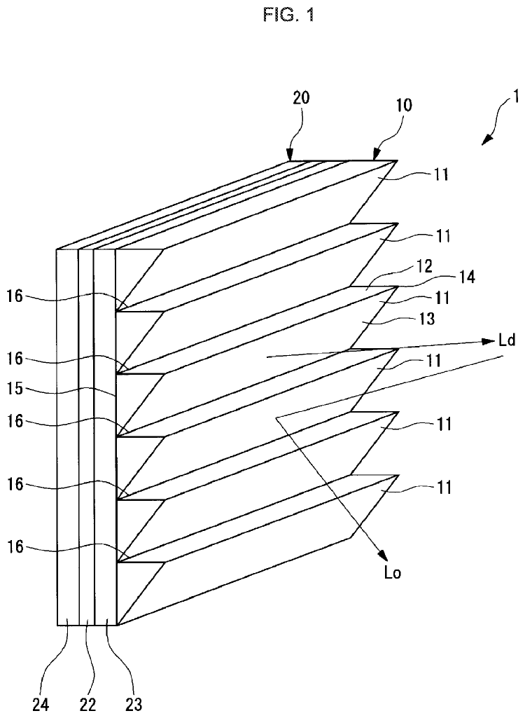

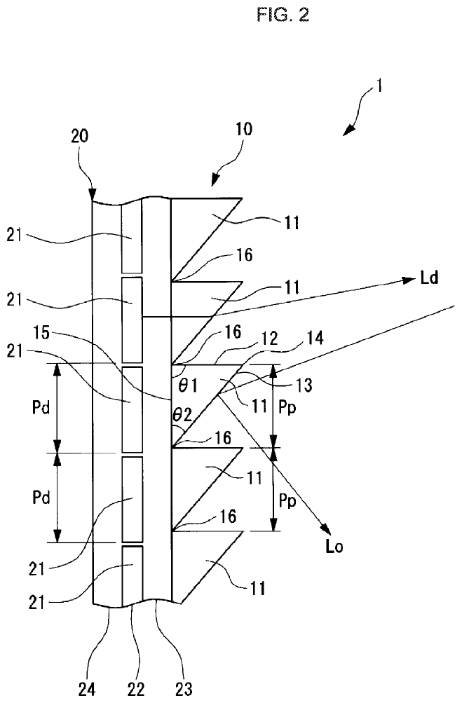

FIG. 1 is a schematic perspective view of a display device in which a prism layer according to the first embodiment is provided in a display. FIG. 2 is a schematic vertical sectional view of the display device in which the prism layer according to the first embodiment is provided in the display.

As illustrated in FIGS. 1 and 2, a prism layer 10 according to the embodiment is laid on the front surface of a display 20. The prism layer 10 is, for example, a transparent cover or film that is stuck to the front surface of a display 20. The surface of the display 20 is given an antiglare function by sticking the prism layer 10 on it. The display 20 on which the prism layer 10 is laid constitutes a display device 1. The display 20 is a high-resolution display and has a pixel density of 200 ppi (pixels per inch) or higher. The display 20 may be of an even higher resolution such as 250 ppi or 300 ppi. The display device 1 is shaped in a rectangle in a plan view and is used in a state that a front-surface-side screen is erected vertically with the bottom side down. The display device 1 is not always used in a vertically erected state but may be used in such a state that its surface is somewhat inclined so that the normal direction of its surface has a vertical component. The display device 1 may have a shape that is not rectangular in a plan view. For example, the display device 1 may have various shapes, including a type that it looks approximately rectangular in a plan view and its corner portions are arc-shaped or have cuts, a type that it looks circular or elliptical in a plan view, and a type that its surface is curved. For example, the display device 1 is used suitably as a display device of a navigation device or an instrument panel installed in a vehicle such as an automobile. Furthermore, the display device 1 is also used as a monitor of a laptop or desktop personal computer.

The display 20 of the display device 1, for example, is a liquid crystal display, an organic EL (electroluminescence) display, or the like. Examples of the organic EL display include one using an organic light-emitting diode (OLED) and one using a light-emitting polymer (LEP). The display 20 is equipped with a display layer 22 having plural pixels 21, a surface layer 23 that covers the surface side of the display layer 22, and a back layer 24 that covers the back side of the display layer 22. In the case where the display 20 is, for example, a liquid crystal display, the surface layer 23 includes a color filter, a polarizing film, a protection film, etc. and the back layer 24 includes a TFT liquid crystal layer, a polarizing film, a protection film, etc. In addition, in the case where the display 20 is a liquid crystal display, it has a configuration that the back layer 24 further includes a back light.

The prism layer 10 according to the embodiment is made of a transparent material. This prism layer 10 is disposed in such a manner that its back surface is laid on the front surface of the display 20. And, this prism layer 10 transmits, to the front side, display light Ld coming from the display 20. As a result, an image, a text, or the like displayed on the display 20 can be seen from the front side of the display device 1.

In the prism layer 10, plural prism portions 11 that are provided by forming grooves 16 in the horizontal direction are arranged in the top-bottom direction. The term “horizontal direction” as used in this example is not limited to a case that the grooves of the prism layer are disposed so as not to be inclined from the completely horizontal direction (inclination: 0°) but includes a case that they are inclined by about 0° to 10°.

Each of the prism portions 11 has a top slope 12 and a bottom slope 13 that are inclined forward from a back surface 15-side. As a result, a corner portion 14, formed by the top slope 12 and the bottom slope 13, of each prism portion 11 has a triangular sectional shape that projects forward.

The angle θ1 of the top slope 12 with respect to the back surface 15 is 60° or larger and 120° or smaller and the angle θ2 of the bottom slope 13 with respect to the back surface 15 is 5° or larger and 45° or smaller. It is preferable that the angle θ1 of the top slope 12 with respect to the back surface 15 be 70° or larger and 90° or smaller and the angle θ2 of the bottom slope 13 with respect to the back surface 15 be 15° or larger and 35° or smaller. With this measure, in the display device 1 which is equipped with the prism layer 10, external light Lo coming from the front side is reflected downward by the bottom slopes 13 of the prism portions 11. Part of the external light Lo coming from the front side is reflected upward by the top slopes 12 of the prism portions 11 of the prism layer 10.

In the prism layer 10, the grooves 16 formed between the prism portions 11 are arranged at the same pitch Pp in the top-bottom direction. The pitch Pp of the grooves 16 is set smaller than the pitch Pd of the pixels 21 of the display 20 in the top-bottom direction.

The term “pixel” as used here means a square-shaped minimum repetition unit as a collection of plural subpixels of, for example, red, green, and blue, and the term “pitch Pd of the pixels 21 in the top-bottom direction” in this example means a pitch, in the top-bottom direction, of units each of which is a collection of plural subpixels. Each unit does not always consist of subpixels of red, green, and blue and may be a collection of subpixels of four colors of red, green, and blue plus white or yellow. Furthermore, each unit as a collection of plural subpixels is not limited to a square one and may be of, for example, a pen-tile arrangement in which the apparent number of pixels is made larger than an actual number by changing the colors and arrangement of subpixels. In the case of such a pen-tile arrangement, the pitch, in the top-bottom direction, of the minimum repetition unit of all subpixels may be employed as the pitch Pd of the pixels 21 in the top-bottom direction. Alternatively, the pitch, in the top-bottom direction, of the minimum repetition unit focusing only on green subpixels may be employed as the pitch Pd of the pixels 21 in the top-bottom direction. The term “pitch in the top-bottom direction” as used here means a pitch measured in the direction that is perpendicular to the prism grooves.

Example structures of the prism layer 10 will be described here.

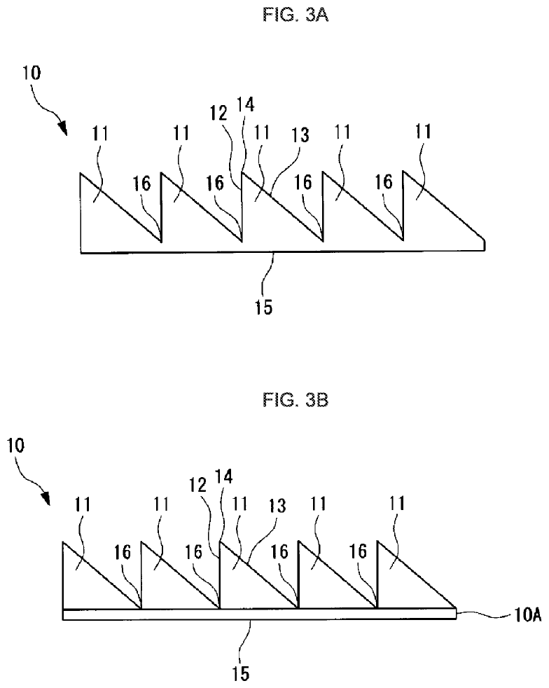

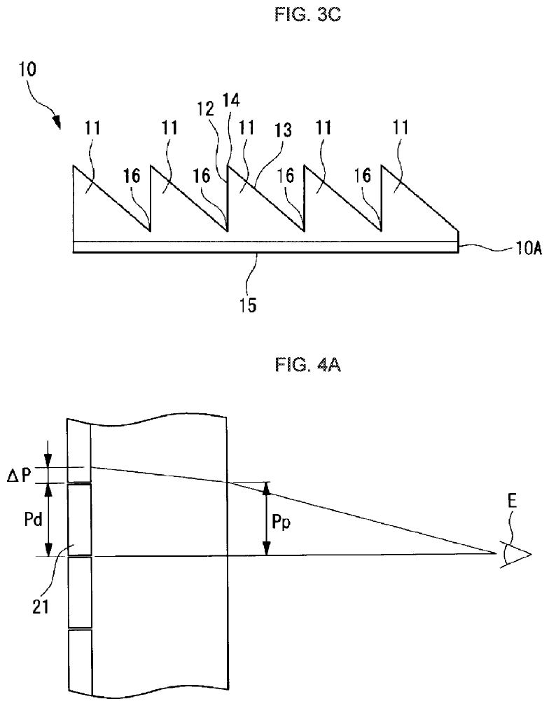

Each of FIGS. 3A-3C is a schematic vertical sectional view for description of an example structure of the prism layer.

The prism layer 10 illustrated in FIG. 3A is made of a transparent material such as a transparent resin or glass. This prism layer 10 is manufactured by providing prism portions 11 by forming grooves 16 in a substrate made of the transparent material. The glass to form the prism layer may be a chemically strengthened glass or a physically strengthened glass. The method for forming the prism portions 11 may be injection molding or press molding that is performed on glass, resin, or the like. Examples of the transparent resin material include an epoxy material, a urethane material, a silicone material, a polycarbonate material, a polystyrene material, and a polyethylene material. Examples of the glass materials include an aluminosilicate glass, a soda glass, a borosilicate glass, a quartz glass, a non-alkaline glass, and a crystallized glass.

In the prism layer 10 illustrated in FIG. 3B, prism portions 11 made of a transparent resin are provided on a substrate 10A which is a glass plate. This prism layer 10 is manufactured by transferring the prism portions 11 to the substrate 10A. The prism portions 11 may be made of transparent glass frit.

In the prism layer 10 illustrated in FIG. 3C, a transparent resin-made film having prism portions 11 formed integrally is laid on a substrate 10A which is a glass plate. This prism layer 10 is manufactured by obtaining the prism portions 11 by forming grooves 16 in a transparent resin-made film and then sticking this film to the substrate 10A which is the glass plate.

When stuck to the front surface of the display 20, the prism layer 10 according to the embodiment having the above structure can reflect external light Lo shining on the screen downward by, in particular, the bottom slopes 13 of the prism portions 11 thereby restraining reflection to a region in front of the screen, and thus, glare can be suppressed effectively and washout can also be suppressed. Furthermore, even in the case where the display 20 is a high-resolution display having a pixel density of 200 ppi or higher, unevenness due to moire can be suppressed because the pitch Pp of the grooves 16 formed between the prism portions 11 is set smaller than the pitch Pd of the pixels 21 of the display 20 in the top-bottom direction.

In addition, diffraction occurs when light is reflected by an array of prisms that are arranged periodically. Influence of diffraction light can be lowered more by coating the surface of the prism layer 10 with an antireflection coating.

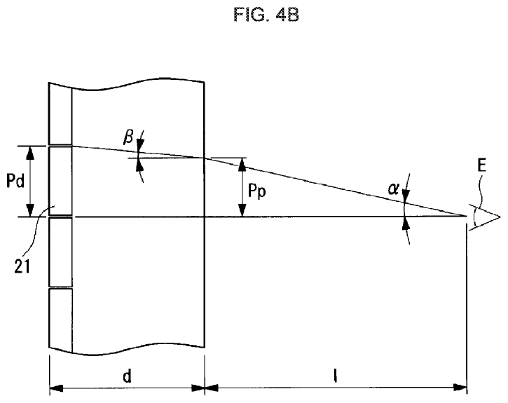

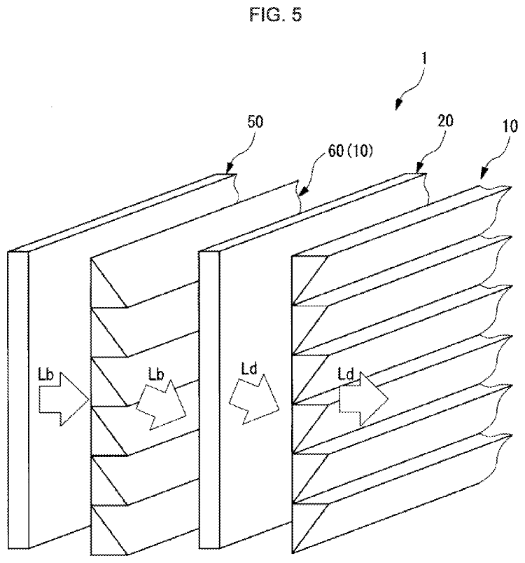

Incidentally, it is conceivable to set the pitch Pp of the grooves 16 of the prism layer 10 equal to the pitch Pd of the pixels 21 of the display 20 in the top-bottom direction (see FIG. 4A). However, the prism portions 11 are disposed slightly in front of the pixels 21. Thus, if the pitch Pd of the pixels 21 in the top-bottom direction is equal to the pitch Pp of the grooves 16 formed between the prism portions 11, a very small apparent deviation ΔP occurs between the pitch Pd of the pixels 21 in the top-bottom direction as seen through the prism layer 10 and the pitch Pp of the grooves 16 formed between the prism portions 11 when they are seen from an observation point E that is located in front of the display device 1, as a result of which long-pitch unevenness occurs due to moire.

It is therefore preferable that as illustrated in FIG. 4B the pitch Pp of the grooves 16 formed between the prism portions 11 be made apparently equal to the pitch Pd of the pixels 21 in the top-bottom direction when they are seen from the observation point E by making the pitch Pp of the grooves 16 formed between the prism portions 11 a little smaller than the pitch Pd of the pixels 21 in the top-bottom direction. With this measure, moire can be suppressed that occurs due to a difference between the pitch of the prism portions 11 and that of the pixels 21 of the display 20.

In this case, the pitch Pd of the pixels 21 in the top-bottom direction and the pitch Pp of the grooves 16 formed between the prism portions 11 have a relationship that is given by the following Equation (1):

$$\begin{matrix}Pd = 1 tan α + d tan β \\ = Pp + d tan B \\ \approx Pp + d sin β\end{matrix} \qquad ( 1 )$$

where

l: a distance from the observation point E to the prism layer 10;

d: a thickness of the front layer 23 of the display 20;

α: an angle of display light at the observation point E; and

β: an angle of display light on the surface of the prism layer 10.

The refractive index na of air and the refractive index nc of the front layer 23 of the display 20 have a relationship that is given by the following Equation (2):

na sin α=nc sin β (2)

The above Equation (1) is modified into the following Equation (3) using the above Equation (2):

$$\begin{matrix}Pd = Pp + d \frac{n a}{nc} sin α \\ \approx Pp + d \frac{n a}{n c} \frac{P d}{1}\end{matrix} \qquad ( 3 )$$

From the above Equation (3), the pitch Pp of the grooves 16 formed between the prism portions 11 is given by the following Equation (4). That is, when the pitch Pp of the grooves 16 is made slightly smaller than the pitch Pd of the pixels 21 in the top-bottom direction, they apparently coincide with each other.

$$\begin{matrix}Pp = ( 1 - \frac{d}{1} \frac{n a}{n c} ) Pd \\ = ( 1 - k ) Pd\end{matrix} \qquad ( 4 )$$

where k is a correction coefficient.

As seen from the above Equation (4), the pitch Pp of the grooves 16 formed between the prism portions 11 can be made apparently equal to the pitch Pd of the pixels 21 in the top-bottom direction by making the pitch Pp of the grooves 16 formed between the prism portions 11 smaller than the pitch Pd of the pixels 21 in the top-bottom direction taking into consideration the correction coefficient k that reflects the thickness and the refractive index of the front layer 23. This measure makes it possible to satisfactorily suppress moire that occurs due to the difference between the pitch of the pixels 21 of the display 20 and that of the prism portions 11.

Alternatively, to suppress moire that occurs due to the difference between the pitch of the pixels 21 of the display 20 and that of the prism portions 11, the pitch Pp of the grooves 16 formed between the prism portions 11 may be made sufficiently smaller than the pitch Pd of the pixels 21 in the top-bottom direction. Specifically, the pitch Pp of the grooves 16 formed between the prism portions 11 may be made 50% or smaller than the pitch Pd of the pixels 21 in the top-bottom direction. This measure makes it possible to suppress moire effectively. The pitch Pp of the grooves 16 formed between the prism portions 11 may be 50% or smaller, 30% or smaller, or 20% or smaller than the pitch Pd of the pixels 21 in the top-bottom direction. However, since diffraction light tends to be more conspicuous as the pitch Pp of the grooves 16 becomes smaller, it is preferable that the pitch Pp be a certain value or larger, for example, 5 μm or larger or 10 μm or larger.

Furthermore, in the display device 1 which is equipped with the prism layer 10, it is preferable that the optical distance from the pixels 21 of the display 20 to the back surface 15 be 3 mm or smaller. The optical distance is obtained by dividing a geometrical distance by the refractive index of a substance. In the case where the optical distance from the pixels 21 of the display 20 to the back surface 15 is 3 mm or smaller, the deviation between display light that has been emitted from the pixels 21 and passed through the prism layer 10 and diffraction light produced by the prism portions 11 of the prism layer 10 can be suppressed and formation of a double image can thereby be avoided.

Still further, it is preferable to make the prism layer 10 closely contact to the front surface of the display 20 by an optical adhesive sheet such as an OCA (optical clear adhesive), to thereby allow external light Lo coming from the front side to be reflected only on the front surface side of the prism layer 10.

Influence of reflection light of external light Lo coming from the front side can be suppressed by allowing the external light Lo to be reflected only on the front surface side of the prism layer 10.

Alternatively, an air layer may be formed between the prism layer 10 and the front surface of the display 20 instead of the prism layer 10 being in close contact to the front surface of the display 20. In this case, it is preferable that an antireflection layer be formed on each of the surface of the display 20 and the back surface 15 of the prism layer 10. Examples of the antireflection layer include an antireflection film using an optical multilayer film and an antireflection layer in which a moth-eye structure is formed by a fine bumps-and-dips structure.

Incidentally, in the display device 1 which is equipped with the prism layer 10, display light Ld emitted from the display 20 is bent by the bottom slopes 13 of the prism layer 10 and thereby guided obliquely upward slightly. Thus, it is preferable that display light Ld emitted from the display 20 of the display device 1 shine on the prism layer 10 in such a state as to have a downward component. In this case, the display light Ld that is emitted from the display 20 so as to have a downward component is bent by the bottom slopes 13 of the prism layer 10 and thereby guided forward to the observer side. This measure increases the visibility of the display device 1 on its front side.

FIG. 5 is a schematic exploded perspective view illustrating a display device according to a modification in which a display is provided with a prism layer.

As illustrated in FIG. 5, in this display device 1, a backlight 50 is provided on the side, opposite to the prism layer 10, of a display 20 which is a liquid crystal display. Illumination light Lb emitted from the backlight 50 is guided to the display 20 and then shined on the prism layer 10 as display light Ld emitted from the display 20. This display device 1 is equipped with, between the display 20 and the backlight 50, a lightguide layer 60 for guiding the illumination light Lb emitted from the backlight 50 to the display 20 so as to have a downward component. For example, the same prism layer 10 as employed in the embodiment can be used as the lightguide layer 60. In the case where this prism layer 10 is used, it is disposed upside down. As a result, the illumination light Lb emitted from the backlight 50 is bent downward by the bottom slopes 13 of the prism layer 10 that serves as the lightguide layer 60 and then guided to the display 20, and the display light Ld that shines on the prism layer 10 from the display 20 comes to have a downward component. As a result, this display light Ld having a downward component is bent by the bottom slopes 13 of the prism layer 10 and then guided forward to the observer side. The visibility of the display device 1 is therefore increased on its front side. Although the above description is directed to the case of using the same prism layer 10, a prism layer 10 having a different shape may be used.

### Second Embodiment

Next, a display device according to a second embodiment will be described.

Descriptions of the same constituent elements as in the above first embodiment will be omitted by giving them the same symbols as in the above first embodiment. However, θ, α, β, l, k, and Pd will be used as having different meanings than in the first embodiment.

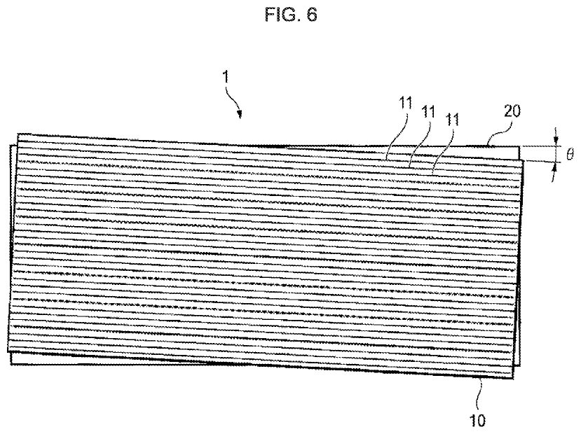

The present inventor has made further studies and found that moire occurs if a slight deviation exists even if the pitch of the prism portions 11 is made apparently equal to the pitch of the pixels 21 when they are seen from a forward observation point by making the pitch of the prism portions 11 smaller than the pitch of the pixels 21 in the top-bottom direction in the display device 1 in which the prism layer 10 is laid on the display 20 (see FIG. 4B). The inventor has also found that there may be a case that moire occurs and a case that moire does not occur, even in a situation that the pitches do not coincide with each other. Furthermore, the inventor has found that when the prism layer 10 is inclined with respect to the display 20 with an inclination angle θ (see FIG. 6), at a particular inclination angle θ the pitch of moire fringes becomes large and they are visually recognizable clearly and at a certain inclination angle θ the pitch of moire fringes becomes small and they are difficult to be recognized visually.

The inventor has made still further studies diligently and found that moire is formed by many concurrent sets of moire fringes having different pitches and directions and the moire can be suppressed to such a level as not to be recognized visually when a maximum value Pmmax(θ, Pd, Pp) of the pitch Pm of the moire fringes becomes 500 μm or smaller.

However, if the inclination angle θ of the prism layer 10 with respect to the display 20 is too large, the effect of the bottom slopes 13 of the prism portions 11 to guide external light downward is lowered, as a result of which the effects of suppressing glare and washout are lowered.

In addition, if the pitch Pp of the prism portions 11 of the prism layer 10 is too small, an iridescent phenomenon occurs as an influence of diffraction.

Based on the above facts, the inventor has found out the following conditions (1)-(3) for suppressing occurrence of an iridescent phenomenon and production of moire by moire fringes while allowing the prism layer 10 to exhibit an antiglare function:

Pmmax(θ,Pd,Pp)≤500 μm; Condition (1):

θ≤30°; and condition (2):

Pp≥20 μm condition (3):

where

Pmmax: a maximum value of pitches Pm of moire fringes;

Pd: a pitch of the pixels 21 of the display 20;

Pp: a pitch of the prism portions 11; and

θ: an inclination angle of the prism layer 10 with respect to the display 20.

In addition, it is preferable that the pixel density of the display 20 that constitutes the display device 1 be 120 ppi or higher.

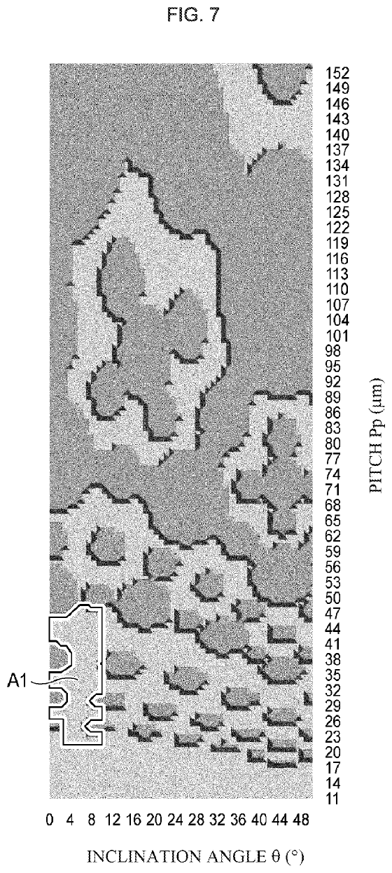

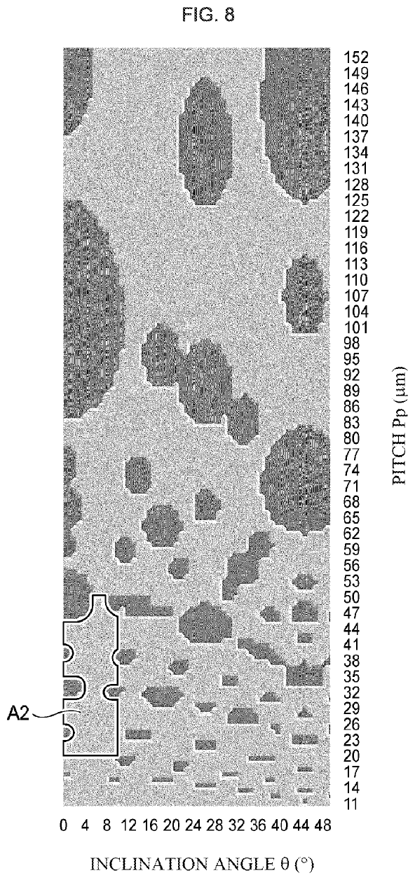

FIG. 7 is a schematic diagram in which in a display device 1 consisting of a display 20 having the pitch Pd of pixels 21 of 152 μm and a prism layer 10 regions where the maximum value Pmmax(θ, Pd, Pp) of the pitch Pm of moire fringes is 500 μm or smaller are drawn light and regions where the maximum value Pmmax(θ, Pd, Pp) is larger than 500 μm are drawn dark. FIG. 8 is a schematic diagram in which in a display device 1 consisting of a display 20 having the pitch Pd of pixels 21 of 100 μm and a prism layer 10 regions where the maximum value Pmmax(θ, Pd, Pp) of the pitch Pm of moire fringes is 500 μm or smaller are drawn light and regions where the maximum value Pmmax(θ, Pd, Pp) is larger than 500 μm are drawn dark. The horizontal axis represents the inclination angle θ of the prism layer 10 and the vertical axis represents the pitch Pp of the prism portions 11.

The regions that are drawn light in FIG. 7 are regions where the maximum value Pmmax(θ, Pd, Pp) of the pitch Pm of moire fringes is 500 μm or smaller in the case that the pitch Pd of pixels 21 of the display 20 is 152 μm and hence moire is difficult to be recognized visually. Furthermore, in these regions, occurrence of an iridescent phenomenon is suppressed while the effect of guiding reflection light is obtained in the case that the inclination angle θ is 30° or smaller and the pitch Pp of the prism portions 11 is 20 μm or larger. Still further, the effect of guiding reflection light can be enhanced by setting the inclination angle θ of the prism layer 10 20° or smaller or 10° or smaller. Moreover, moire becomes more difficult to be recognized visually by setting the pitch Pp of the prism portions 11 to be the pitch Pd of the pixels 21 or smaller, Pd/2 or smaller, or Pd/3 or smaller. In FIG. 7, the region A1 denotes an example region where the maximum value Pmmax(θ, Pd, Pp) of the pitch Pm of moire fringes is 500 μm or smaller in the case that the inclination angle θ of the prism layer 10 is 10° or smaller and the pitch Pp of the prism portions 11 is 20 μm or larger and Pd/3 or smaller. In the case where the pitch Pd of the pixels 21 of the display 20 is 152 μm, occurrence of an iridescent phenomenon and production of moire by moire fringes can be suppressed more effectively while the prism layer 10 is allowed to exhibit an antiglare function by establishing conditions that enable falling into the region A1.

The regions that are drawn light in FIG. 8 are regions where the maximum value Pmmax(θ, Pd, Pp) of the pitch Pm of moire fringes is 500 μm or smaller in the case that the pitch Pd of pixels 21 of the display 20 is 100 μm and hence moire is difficult to be recognized visually. Furthermore, in these regions, occurrence of an iridescent phenomenon is suppressed while the effect of guiding reflection light is obtained in the case that the inclination angle θ is 30° or smaller and the pitch Pp of the prism portions 11 is 20 μm or larger. Still further, the effect of guiding reflection light can be enhanced by setting the inclination angle θ of the prism layer 10 20° or smaller or 10° or smaller. Moreover, moire becomes more difficult to be recognized visually by setting the pitch Pp of the prism portions 11 to be the pitch Pd of the pixels 21 or smaller, Pd/2 or smaller, or Pd/3 or smaller. In FIG. 8, the region A2 denotes an example region where the maximum value Pmmax(θ, Pd, Pp) of the pitch Pm of moire fringes is 500 μm or smaller in the case that the inclination angle θ of the prism layer 10 is 10° or smaller and the pitch Pp of the prism portions 11 is 20 μm or larger and Pd/2 or smaller. In the case where the pitch Pd of the pixels 21 of the display 20 is 100 μm, occurrence of an iridescent phenomenon and production of moire by moire fringes can be suppressed more effectively while the prism layer 10 is allowed to exhibit an antiglare function by establishing conditions that enable falling into the region A2.

### (Method for Determining a Pitch of Moire Fringes)

Next, a method for determining a pitch Pm of moire fringes will be described.

As illustrated in FIG. 9, where stripes originating from the pixels of the display 20 are arranged parallel with the x axis at a pitch p1, these stripes are represented by the following Equation (5):

y/p₁=n₁ (5)

where n₁ is an integer.

On the other hand, where stripes of the prism portions 11 of the prism layer 10 are arranged at a pitch p2 with a gradient β with respect to the x axis, these stripes are represented by the following Equation (6):

$$y = tan β \cdot x + \frac{{n}_{2} {p}_{2}}{cos β} \qquad ( 6 )$$

where n₂ is an integer.

Moire fringes (indicated by broken lines in FIG. 9) formed by these two sets of stripes are called “order-different moire” and identified by an integer m=n₁−n₂. Specifically, it is identified by the following Equation (7) which is obtained by substituting Equations (5) and (6) into n₁−n₂=m:

$$\begin{matrix}[ Formula 7 ] & \\ y = \frac{{p}_{1} sin β}{{p}_{2} - {p}_{1} cos β} x - \frac{{p}_{1} {p}_{2} m}{{p}_{2} - {p}_{1} cos β} & ( 7 )\end{matrix}$$

From this equation, a gradient γ and a pitch Pm of the moire fringes with respect to the stripes originating from the pixels of the display 20 are determined according to the following Equations (8) and (9):

$$γ = {tan}^{- 1} ( \frac{{p}_{1} sin β}{{p}_{2} - {p}_{1} cos β} ) \qquad ( 8 )$$

$$Pm = \frac{{p}_{1} {p}_{2}}{\sqrt{{( {p}_{2} - {p}_{1} cos β )}^{2} + {( {p}_{1} sin β )}^{2}}} \qquad ( 9 )$$

Next, the stripes that are formed by the pixels 21 of the display 20 and represented by Equation (5) will be described.

Assume here that RGB pixels are stripes and the pixels 21 are arranged in a two-dimensional square lattice. In this case, there is only one kind of pitch, that is, a pitch of the RGB pixels.

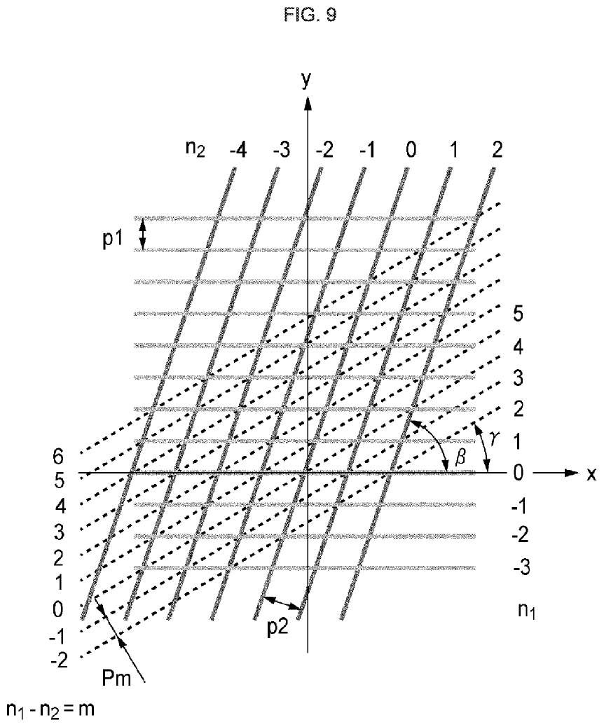

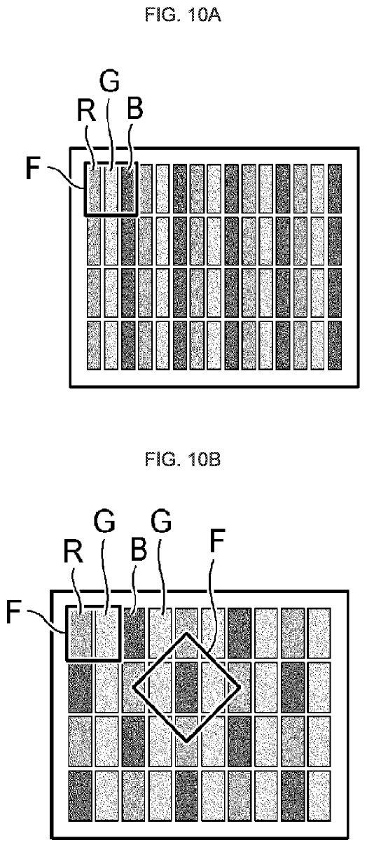

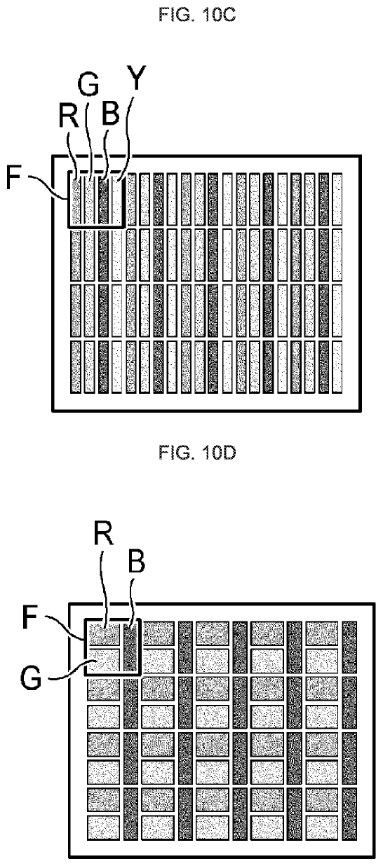

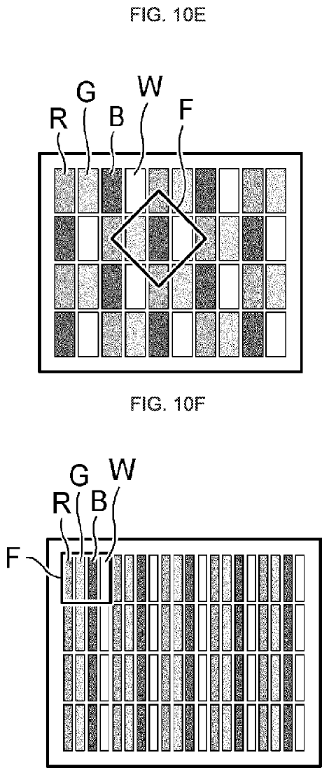

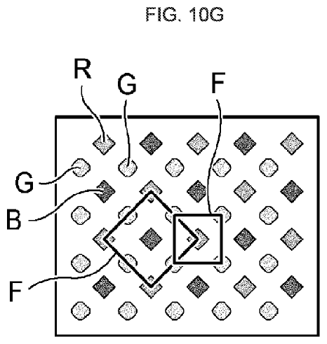

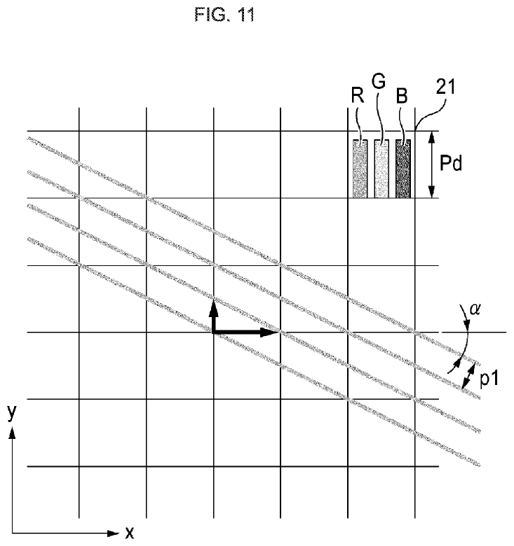

In the case where different pixel arrangements exist as in a pen-tile arrangement, R pixels, G pixels, B pixels, W pixels, Y pixels, RGB pixels, RGBY pixels, and RGBW pixels may have different pitches respectively. In the case where different pixel pitches exist as in this case, a similar calculation is performed on a pitch of particular pixels or on a pitch of all pixels. The term “a pitch of pixels” as used here means a length of a minimum unit of repetition that enables complete filling by the same squares, and is not always arranged in the horizontal and vertical directions and may be arranged in an oblique direction. In this connection, each of FIGS. 10A-10G illustrates a display having various pixel arrangements and each portion enclosed by a frame F can be employed as a minimum unit. As for types of the respective displays illustrated in FIG. 10A-10G, FIG. 10A illustrates stripe RGB, FIG. 10B illustrates pen-tile RGBG, FIG. 10C illustrates QuadPixel RGBY, FIG. 10D illustrates S-stripe RGB, FIG. 10E illustrates pen-tile RGBW, FIG. 10F illustrates white magic RGBW, and FIG. 10G illustrates diamond pen-tile RGBG. That is, each of pen-tile RGBG (FIG. 10B) and diamond pen-tile RGBG (FIG. 10G) has two different pitches.

Assume stripes that are formed by pixels 21 that are arranged as illustrated in FIG. 11. Since an adjacent stripe is spaced by (1/1)Pd in the x-axis direction and (1/2)Pd in the y-axis direction, it is represented by (1, 2). Generalizing this notation, stripes that are arranged so as to be spaced from each other by (1/h)Pd in the x-axis direction and by (1/k)Pd in the y-axis direction can be represented by (h, k). A pitch p₁ and a gradient α with respect to the x axis of these stripes can be represented by the following Equations (10) and (11):

p₁=Pp/\sqrt{h²+k²} (10)

α=tan⁻¹(h/k) (11)

In these equations, h and k are integers of 0 or larger ((h, k) (0, 0) is excluded). Although there may be a case that h and/or k has a negative value, from the viewpoint of symmetry, no problem arises even if they are restricted to integers of 0 or larger.

Next, stripes originating from the prism portions 11 that are represented by Equation (6) will be described. The direction of the stripes is parallel with the prism portions 11 and the pitch p2 can be decomposed into pitches of respective sets of stripes having higher-order frequency components represented by the following Equation (12):

p₂=Pp/l (12)

where l=1, 2, 3, . . . .

Now, a consideration will be given to the case that as illustrated in FIG. 6 the display 20 and the prism layer 10 are arranged with an inclination angle θ.

Since the pitch p₁ and the gradient α of stripes represented by (h, k) are represented by Equations (10) and (11), the angle 13 formed by stripes originating from the pixels 21 of the display 20 and stripes originating from the prism portions 11 is represented by θ−α. The pitch Pm of moire fringes that are formed by two sets of stripes that are identified by 1 and (h, k), respectively, can be determined from this angle β and Equations (9), (10), and (12).

The pitches Pm of moire fringes is calculated for all combinations 1≤l≤3, 0≤h, and k≤6 (the case of h=k=0 is excluded) and a maximum value of the pitch Pm of moire fringes is taken as Pmmax(θ, Pd, Pp).

In the case of the display 20 and the prism layer 10 being discussed, all observed sets of moire fringes can be explained by using combinations of 1≤l≤3, 0≤h, and k≤6 (the case of h=k=0 is excluded). However, conditions to be considered may change if the ease of visual recognition of moire fringes varies due to, for example, increase of the luminance of the display 20. For example, the upper limit of 1 may vary to 2 or 4 or the upper limits of h and k may vary to 3, 4, or 5 and 7 or 8, respectively. In the case where the pitch varies depending on the set of pixels as in pen-tile RGBG, Pmmax is calculated for each of all sets of pixels having different pitches and a maximum value of those values is employed as final Pmmax.

It has been found that moire can be suppressed to a visually unrecognizable level by using a condition that the maximum value Pmmax(θ, Pd, Pp) of the pitch Pm of moire fringes is 500 μm or smaller (condition (1)). However, as mentioned above, if the inclination angle θ is too large, the effect of guiding external light downward by the bottom slopes 13 of the prism portions 11 is lowered. On the other hand, an iridescent phenomenon occurs due to influence of diffraction if the pitch Pp of the prism portions 11 is too small. Thus, to avoid the problems of moire and diffraction while allowing the prism layer 10 to exhibit an antiglare function, it is necessary that Pmmax(θ, Pd, Pp)≤500 μm (condition (1)), θ≤30° (condition (2)), and Pp≥20 μm (condition (3)) be satisfied at the same time.

As for the condition (1) for preventing visual recognition of moire, it is preferable that the maximum value Pmmax(θ, Pd, Pp) of the pitch Pm of moire fringes be 400 μm or smaller, even preferably 300 μm or smaller and further preferably 200 μm or smaller.

As for the condition (2) for obtaining the effect of guiding external light downward, it is preferable that the inclination angle θ of the prism layer 10 with respect to the display 20 be 20° or smaller, even preferably 15° or smaller, further preferably 10° or smaller, and even further preferably 5° or smaller.

Furthermore, as for the condition (3) for rendering coloration by diffraction light inconspicuous, it is preferable that the pitch Pp of the prism portions 11 be 30 μm or larger, even preferably 40 μm or larger, further preferably 50 μm or larger, even further preferably 60 μm or larger, and particularly preferably 70 μm or larger.

Also in the second embodiment, it is preferable that the optical distance from the pixels 21 of the display 20 to the back surface of the prism layer 10 be 3 mm or smaller. This makes it possible to reduce a deviation between the display light that has been emitted from the pixels 21 and passed through the prism layer 10 and diffraction light produced by the prism portions 11 of the prism layer 10 and thereby render the diffraction light inconspicuous.

In addition, also in the second embodiment, the display light emitted from the display 20 may be shined on the prism layer 10 in such a state as to have a downward component by providing, for example, between the display 20 and the backlight 50, the lightguide layer 60 for guiding illumination light emitted from the backlight 50 to the display 20 so as to have a downward component (see FIG. 5). With this measure, the display light emitted from the display 20 in such a state as to have a downward component can be guided forward to the observer side after being bent by the bottom slopes 13 of the prism layer 10, whereby visibility can be increased.

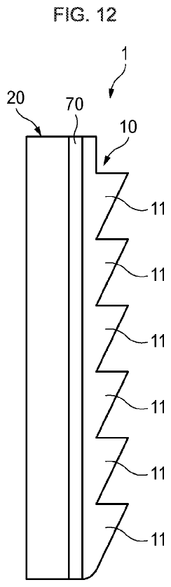

Furthermore, in the above-described first and second embodiments, as illustrated in FIG. 12, a diffusion layer 70 may be provided between the display 20 and the prism layer 10. For example, the diffusion layer 70 may have a haze of 20% or smaller. The insertion of the diffusion layer 70 between the display 20 and the prism layer 10 makes it possible to widen the range where no moire is observed. In this case, the upper limit values of l, h, and k to be taken into consideration in determining Pmmax are made smaller.

Table 1 shows results that were obtained when numerical values were assigned to the pixel pitch Pd of the display 20 and the pitch Pp of the prism portions 11 of the prism layer 10 in the case that stripe RGB or pen-tile RGBG was employed as a pixel pattern of the display. It is understood from these results that Inventive Examples 1-6 are in ranges where moire and washout can be suppressed and Comparative Examples 1-6 are in ranges where moire or washout cannot be suppressed.

TABLE 1

| | Component | | | | | | |
|---|---|---|---|---|---|---|---|
| | | | | | | | Between prism layer and |
| | Display | | Prism layer | | | | display |
| | Item | | | | | | |
| | Pixel pitch | Pixel pattern | Wedge pitch | | | | |
| | Item | | | | | | |
| | | | | | Top slope | Bottom | |
| | p1 | | p2 | θ | angle | slope angle | Distance |
| | Unit | | | | | | |
| | μm | | μm | ° | ° | ° | mm |
| Inv. Ex. 1 | 152 | Stripe RGB | 65 | 0 | 90 | 25 | 1 |
| Inv. Ex. 2 | 152 | Stripe RGB | 51 | 6 | 90 | 25 | 1 |
| Inv. Ex. 3 | 152 | Stripe RGB | 30 | 6 | 90 | 25 | 1 |
| Inv. Ex. 4 | 152 | Stripe RGB | 90 | 7 | 90 | 25 | 1 |
| Inv. Ex. 5 | 152 | Stripe RGB | 51 | 0 | 90 | 25 | 1 |
| Inv. Ex. 6 | 100 | Pen-tile RGBG | 51 | 8 | 90 | 25 | 1 |
| Com. Ex. 1 | 152 | Stripe RGB | 51 | 0 | 90 | 25 | 1 |
| Com. Ex. 2 | 152 | Stripe RGB | 76 | 37 | 90 | 25 | 1 |
| Com. Ex. 3 | 152 | Stripe RGB | 90 | 0 | 90 | 25 | 1 |
| Com. Ex. 4 | 152 | Stripe RGB | 51 | 6 | 50 | 25 | 1 |
| Com. Ex. 5 | 152 | Stripe RGB | 51 | 6 | 90 | 3 | 1 |
| Com. Ex. 6 | 100 | Pen-tile RGBG | 51 | 0 | 90 | 25 | 1 |
| | Component | | | | | | |
| | Between | | | | | | |
| | prism layer | | | | | | |
| | and display | Check results | | | Calculated values | | |
| | Item | | | | | | |
| | | | Iridescent | | | | h and k |
| | Diffusion layer | Moire | diffraction | Washout | Pmmax | l range | ranges |
| | Unit | | | | | | |
| | | | | | μm | | |
| Inv. Ex. 1 | Not provided | Not occurred | Not occurred | Not occurred | 475 | 1-3 | 0-6 |
| Inv. Ex. 2 | Not provided | Not occurred | Not occurred | Not occurred | 485 | 1-3 | 0-6 |
| Inv. Ex. 3 | Not provided | Not occurred | Not occurred | Not occurred | 322 | 1-3 | 0-6 |
| Inv. Ex. 4 | Not provided | Not occurred | Not occurred | Not occurred | 397 | 1-3 | 0-6 |
| Inv. Ex. 5 | Provided | Not occurred | Not occurred | Not occurred | 108 | 1-2 | 0-2 |
| Inv. Ex. 6 | Not provided | Not occurred | Not occurred | Not occurred | 397 | 1-3 | 0-6 |
| Com. Ex. 1 | Not provided | Occurred | Not occurred | Not occurred | 8,619 | 1-3 | 0-6 |
| Com. Ex. 2 | Not provided | Not occurred | Not occurred | Occurred | 347 | 1-3 | 0-6 |
| Com. Ex. 3 | Not provided | Occurred | Not occurred | Not occurred | 2,172 | 1-3 | 0-6 |
| Com. Ex. 4 | Not provided | Not occurred | Not occurred | Occurred | 485 | 1-3 | 0-6 |
| Com. Ex. 5 | Not provided | Not occurred | Not occurred | Occurred | 485 | 1-3 | 0-6 |
| Com. Ex. 6 | Not provided | Occurred | Not occurred | Not occurred | 2,550 | 1-3 | 0-6 |

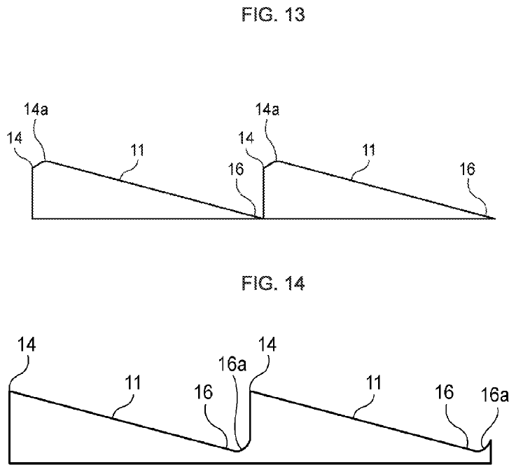

In the above-described first embodiment and second embodiment, as illustrated in FIG. 13, a chamfered portion 14a may be formed at a corner portion 14 of each prism portion 11 of the prism layer 10 by chamfering the prism portion 11 at the corner portion 14. The scratch resistance of each prism portion 11 can be increased by providing the chamfered portion 14a at the corner portion 14 of the prism portion 11. Since the ability to reflect external light downward is lowered if each chamfered portion 14a is too large, it is preferable that the length ratio of the chamfered portion 14a when each prism portion 11 is projected onto a horizontal plane be smaller than 0.2 (20%). In addition, each chamfered portion 14a may either be one chamfered surface that is straight in cross section or consist of plural chamfered surfaces that are continuous with each other or may be a chamfered surface that is arc-shaped in cross section.

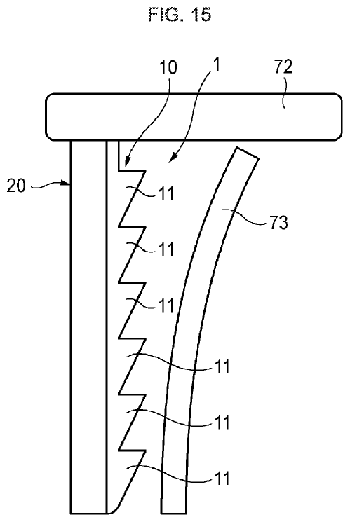

Furthermore, as illustrated in FIG. 14, a curved recess 16a that is arc-shaped in cross section may be formed at each groove 16 between prism portions 11 of the prism layer 10. In the case where the curved recess 16a that is arc-shaped in cross section is thus formed at each groove 16, the moldability of the prism portions 11 is increased and the prism portions 11 can be manufactured easily, and the productivity will be increased. Since the ability to reflect external light downward is lowered if each curved recess 16a is too large, it is preferable that the length ratio of each curved recess 16a when the prism portions 11 are projected onto a horizontal plane be smaller than 0.2 (20%).

Another structure is possible in which a chamfered portion 14a is formed at a corner portion 14 of each prism portion 11 and a curved recess 16a is further formed at each groove 16 between prism portions 11. In this case, a prism layer 10 that is superior in scratch resistance can be manufactured easily.

FIG. 15 is a schematic sectional view of a display device that is equipped with a visor and a shield.

As illustrated in FIG. 15, in the case where the above-described display device 1 according to the first embodiment or the second embodiment is installed, it is preferable that a visor 72 be disposed above the display device 1 and a shield 73 which is a transparent sheet or a transparent film be disposed on the front side of the display device 1. In this case, entrance of external light into the display device 1 can be suppressed by the visor 72 to suppress generation of reflection light by the prism layer 10. Furthermore, an event that a user touches the prism layer 10 of the display device 1 can be prevented by the shield 73, whereby the prism layer 10 can be protected. In addition, it is preferable that the shield 73 be provided (inclined) so as to come closer to the user side as the position goes upward. With this measure, external light can be guided downward on the user side by the shield 73 in the same manner as the reflection of external light by the prism layer 10, whereby the visibility of the display 20 can be increased.

As such, the invention is not limited to the above embodiments. And combining components of the embodiments together and acts that those skilled in the art modify or apply the invention on the basis of the disclosure of the specification and known techniques are expected in the invention and encompassed by the scope of protection.

As described above, the specification discloses the following items:

(1) A prism layer, a back surface of which is disposed so as to be laid on a front surface of a display that is 200 ppi or higher in pixel density and which transmits, to a front side, a display light coming from the display, the prism layer containing

plural prism portions that are formed so as to extend in a horizontal direction and arranged in a top-bottom direction, in which:

each of the prism portions has a top slope, a bottom slope and a corner portion formed by the top slope and the bottom slope, has a triangular sectional shape in which the corner portion projects toward the front side, an angle of the top slope with respect to the back surface is 60° or larger and 120° or smaller, and an angle of the bottom slope with respect to the back surface is 5° or larger and 45° or smaller; and

a pitch of grooves formed between the prism portions is smaller than a pitch of pixels of the display in the top-bottom direction.

According to the prism layer having this configuration, glare can be suppressed effectively by reflecting, downward, external light shining on the screen by the bottom slopes, in particular, of the prism portions and thereby lowering the degree of its reflection to the front side of the screen. Furthermore, even in the case where the display is a high-resolution display whose pixel density is higher than or equal to 200 ppi, since the pitch of the grooves formed between the prism portions is set smaller than the pitch of the pixels of the display in the top-bottom direction, not only sparkling but also moire and washout can be suppressed.

(2) The prism layer according to item (1), in which the pitch of the grooves formed between the prism portions is made apparently equal to the pitch of the pixels in the top-bottom direction when they are seen from an observation point located in the front side by making the pitch of the grooves smaller than the pitch of the pixels in the top-bottom direction.

According to the prism layer having this configuration, since the pitch of the pixels in the top-bottom direction apparently coincides with that of the grooves between the prism portions when viewed from an observation point located on the front side, moire that is produced by pitch differences between the pixels of the display and the prism portions can be suppressed satisfactorily.

(3) The prism layer according to item (1), in which the pitch of the grooves formed between the prism portions is 50% or smaller than the pitch of the pixels in the top-bottom direction.

According to the prism layer having this configuration, since the pitch of the grooves formed between the prism portions is set smaller than or equal to 50% of the pitch of the pixels in the top-bottom direction, moire that is produced by pitch differences between the pixels of the display and the prism portions can be made inconspicuous.

(4) The prism layer according to any one of items (1) to (3), in which the prism portions are formed between the grooves as a result of formation of the plural grooves in a transparent substrate.

According to the prism layer having this configuration, it can be manufactured easily by forming grooves in a substrate made of a transparent material.

(5) The prism layer according to any one of items (1) to (3), in which the plural prism portions made of a transparent resin are transferred on a glass substrate.

According to the prism layer having this configuration, it can be manufactured easily by transferring prism portions made of a transparent resin to a substrate which is a glass plate.

(6) The prism layer according to any one of items (1) to (3), in which a film of a transparent resin containing the plural prism portions formed integrally is laid on a glass substrate.

According to the prism layer having this configuration, it can be manufactured easily by sticking a film that incorporates the prism portions and is made of a transparent resin to a substrate which is a glass plate.

(7) A display device, containing the prism layer as described in any one of items (1) to (6) and a display that is 200 ppi or higher in pixel density, in which the prism layer is laid on a front surface of the display.

According to the display device having this configuration, glare can be suppressed effectively by reflecting, downward, external light shining on the screen by the bottom slopes, in particular, of the prism portions and thereby lowering the degree of its reflection to the front side of the screen. Furthermore, even in the case where the display is a high-resolution display whose pixel density is higher than or equal to 200 ppi, since the pitch formed between the prism portions is set smaller than the pitch of pixels of the display in the top-bottom direction, not only sparkling but also moire and washout can be suppressed.

(8) The display device according to item (7), in which an optical distance from the pixels of the display to the back surface of the prism layer is 3 mm or smaller.

According to the display device having this configuration, a deviation between display light that has been emitted from the pixels and passed through the prism layer and diffraction light produced by the prism portions of the prism layer is reduced, whereby the diffraction light can be rendered inconspicuous.

(9) The display device according to item (7) or (8), in which the display light coming from the display shines on the prism layer in such a state as to have a downward component.

According to the display device having this configuration, display light emitted from the display in such a state as to have a downward component can be guided forward to the observer side after being bent by the bottom slopes of the prism layer, whereby visibility can be increased.

(10) The display device according to item (9), in which:

the display is a liquid crystal display containing a backlight that is disposed on the side opposite to the prism layer; and

the display device contains a lightguide layer between the display and the backlight, and the lightguide layer guides an illumination light emitted from the backlight to the display so as to have a downward component.

According to the display device having this configuration, illumination light emitted from the backlight is bent downward by the lightguide layer and then guided to the display, and display light that shines on the prism layer from the display comes to have a downward component. As a result, display light that is emitted from the display so as to have a downward component is bent by the bottom slopes of the prism layer and then guided forward to the observer side, whereby visibility can be increased.

(11) A display device containing:

a display; and

a prism layer which is disposed in such a manner that its back surface is laid on a front surface of the display and transmits, to a front side, a display light coming from the display, in which:

the prism layer contains plural prism portions formed so as to extend in a width direction and arranged in a top-bottom direction;

each of the prism portions has a top slope, a bottom slope and a corner portion formed by the top slope and the bottom slope, has a triangular sectional shape in which the corner portion projects toward the front side, an angle of the top slope with respect to the back surface is 60° or larger and 120° or smaller, and an angle of the bottom slope with respect to the back surface is 5° or larger and 45° or smaller;

the prism layer is disposed so as to be inclined or not to be inclined with respect to an arrangement direction in a width direction of pixels of the display; and

Pmmax(θ,Pd,Pp)≤500 μm;

θ≤30°; and

Pp≥20 μm

are satisfied, where θ is an inclination angle of the prism layer with respect to the display, Pd is a pitch of the pixels of the display, Pp is a pitch of the prism portions, Pm is a pitch of moire fringes that occur, and Pmmax(θ, Pd, Pp) is a maximum value of the pitch Pm of the moire fringes.

According to this display device, since the maximum value Pmmax(θ, Pd, Pp) of pitches Pm's of sets of moire fringes is smaller than or equal to 500 moire can be suppressed to such an extent as not to be recognized visually. Since the inclination angle θ of the prism layer with respect to the display is set smaller than or equal to 30°, an effect of guiding external light downward by the bottom slopes of the prism portions can be obtained satisfactorily. Furthermore, since the pitch Pp of the prism portions is set larger than or equal to 20 μm, occurrence of an iridescent phenomenon through influence of diffraction can be suppressed.

(12) The display device according to item (11), in which the display has a pixel density of 120 ppi or higher.

According to this display device, the prism layer is allowed to exhibit an antiglare function and moire and diffraction problems can be avoided even in a case that the display device is equipped with a high-resolution display whose pixel density is higher than or equal to 120 ppi.

(13) The display device according to item (11) or (12), in which an optical distance from the pixels of the display to the back surface of the prism layer is 3 mm or smaller.

According to the display device having this configuration, a deviation between display light that has been emitted from the pixels and passed through the prism layer and diffraction light produced by the prism portions of the prism layer is reduced, whereby the diffraction light can be rendered inconspicuous.

(14) The display device according to any one of items (11) to (13), in which the display light coming from the display shines on the prism layer in such a state as to have a downward component.

According to the display device having this configuration, display light emitted from the display in such a state as to have a downward component can be guided forward to the observer side after being bent by the bottom slopes of the prism layer, whereby visibility can be increased.

(15) The display device according to item (14), in which:

the display is a liquid crystal display containing a backlight that is disposed on the side opposite to the prism layer; and

the display device contains a lightguide layer between the display and the backlight, and the lightguide layer guides an illumination light emitted from the backlight to the display so as to have a downward component.

According to the display device having this configuration, illumination light emitted from the backlight is bent downward by the lightguide layer and then guided to the display, and display light that shines on the prism layer from the display comes to have a downward component. As a result, display light that is emitted from the display so as to have a downward component can be bent by the bottom slopes of the prism layer and then guided forward to the observer side, whereby visibility can be increased.

Although the invention has been described in detail by referring to the particular embodiments, it is apparent to those skilled in the art that various changes and modifications are possible without departing from the spirit and scope of the invention. The present application is based on Japanese Patent Application No. 2020-023774 filed on Feb. 14, 2020 and No. 2021-000196 filed on Jan. 4, 2021, the disclosures of which are incorporated herein by reference.

### DESCRIPTION OF SYMBOLS

10: Prism layer
10A: Substrate
11: Prism portion
12: Top slope
13: Bottom slope
14: Corner portion
15: Back surface
16: Groove
20: Display
21: Pixel
50: Backlight
60: Lightguide layer
Ld: Display light
Lo: External light
Pd, Pp: Pitch
θ1, θ2: Angle
θ: Inclination angle
Pm: Pitch of moire fringes
Pmmax: Maximum value of pitches of sets of moire fringes

1. A prism layer, a back surface of which is disposed so as to be laid on a front surface of a display that is 200 ppi or higher in pixel density and which transmits, to a front side, a display light coming from the display, the prism layer comprising
plural prism portions that are formed so as to extend in a horizontal direction and arranged in a top-bottom direction, wherein:
each of the prism portions has a top slope, a bottom slope and a corner portion formed by the top slope and the bottom slope, has a triangular sectional shape in which the corner portion projects toward the front side, an angle of the top slope with respect to the back surface is 60° or larger and 120° or smaller, and an angle of the bottom slope with respect to the back surface is 5° or larger and 45° or smaller; and
a pitch of grooves formed between the prism portions is smaller than a pitch of pixels of the display in the top-bottom direction.

2. The prism layer according to claim 1, wherein the pitch of the grooves formed between the prism portions is made apparently equal to the pitch of the pixels in the top-bottom direction when they are seen from an observation point located in the front side by making the pitch of the grooves smaller than the pitch of the pixels in the top-bottom direction.

3. The prism layer according to claim 1, wherein the pitch of the grooves formed between the prism portions is 50% or smaller than the pitch of the pixels in the top-bottom direction.

4. The prism layer according to claim 1, wherein the prism portions are formed between the grooves as a result of formation of the plural grooves in a transparent substrate.

5. The prism layer according to claim 1, wherein the plural prism portions made of a transparent resin are transferred on a glass substrate.

6. The prism layer according to claim 1, wherein a film of a transparent resin comprising the plural prism portions formed integrally is laid on a glass substrate.

7. A display device, comprising the prism layer as described in claim 1 and a display that is 200 ppi or higher in pixel density, wherein the prism layer is laid on a front surface of the display.

8. The display device according to claim 7, wherein an optical distance from the pixels of the display to the back surface of the prism layer is 3 mm or smaller.

9. The display device according to claim 7, wherein the display light coming from the display shines on the prism layer in such a state as to have a downward component.

10. The display device according to claim 9, wherein:
the display is a liquid crystal display comprising a backlight that is disposed on the side opposite to the prism layer; and
the display device comprises a lightguide layer between the display and the backlight, and the lightguide layer guides an illumination light emitted from the backlight to the display so as to have a downward component.

11. A display device comprising:
a display; and
a prism layer which is disposed in such a manner that its back surface is laid on a front surface of the display and transmits, to a front side, a display light coming from the display, wherein:
the prism layer comprises plural prism portions formed so as to extend in a width direction and arranged in a top-bottom direction;
each of the prism portions has a top slope, a bottom slope and a corner portion formed by the top slope and the bottom slope, has a triangular sectional shape in which the corner portion projects toward the front side, an angle of the top slope with respect to the back surface is 60° or larger and 120° or smaller, and an angle of the bottom slope with respect to the back surface is 5° or larger and 45° or smaller;
the prism layer is disposed so as to be inclined or not to be inclined with respect to an arrangement direction in a width direction of pixels of the display; and
Pmmax(θ,Pd,Pp)≤500 μm;
θ≤30°; and
Pp≥20 μm
are satisfied, where θ is an inclination angle of the prism layer with respect to the display, Pd is a pitch of the pixels of the display, Pp is a pitch of the prism portions, Pm is a pitch of moire fringes that occur, and Pmmax(θ, Pd, Pp) is a maximum value of the pitch Pm of the moire fringes.

12. The display device according to claim 11, wherein the display has a pixel density of 120 ppi or higher.

13. The display device according to claim 11, wherein an optical distance from the pixels of the display to the back surface of the prism layer is 3 mm or smaller.

14. The display device according to claim 11, wherein the display light coming from the display shines on the prism layer in such a state as to have a downward component.

15. The display device according to claim 14, wherein:
the display is a liquid crystal display comprising a backlight that is disposed on the side opposite to the prism layer; and
the display device comprises a lightguide layer between the display and the backlight, and the lightguide layer guides an illumination light emitted from the backlight to the display so as to have a downward component.
